(19) United States
(12) Patent Application Publication
(10) Pub. No.: US 2024/0247210 A1
(43) Pub. Date: Jul. 25, 2024

(54) ACIDIC FABRIC CARE COMPOSITIONS

(71) Applicant: The Procter & Gamble Company, Cincinnati, OH (US)

(72) Inventors: Neil Joseph LANT, Newcastle upon Tyne (GB); Samuel Kimani NJOROGE, Montgomery, OH (US); Todd Michael WERNICKE, Cincinnati, OH (US)

(21) Appl. No.: 18/418,465

(22) Filed: Jan. 22, 2024

Related U.S. Application Data
(60) Provisional application No. 63/440,709, filed on Jan. 24, 2023.

(51) Int. Cl. C11D 3/38; C11D 1/66; C11D 3/00; C11D 3/04; C11D 3/20; C11D 3/395; C11D 3/50

(52) U.S. Cl. CPC C11D 3/381; C11D 1/66; C11D 3/001; C11D 3/046; C11D 3/2082; C11D 3/395; C11D 3/50; C11D 2111/12

(57) ABSTRACT

A liquid fabric care composition including an organic acid and/or a salt thereof, Bacillus spores, a fragrance material comprising aldehydic perfume raw materials, water and wherein the composition includes less than 10%, by weight of the liquid fabric care composition, of a material selected from the group consisting of detersive surfactant, bleaching systems, fabric softening materials, and mixtures thereof and wherein the liquid fabric care composition has a neat pH of from about 2 to about 4.

### FIELD OF THE INVENTION

The present disclosure relates to an acidic fabric care composition that includes: an organic acid and/or a salt thereof, Bacillus spores, a fragrance material comprising aldehydic perfume raw materials and water. The present disclosure also relates to methods of using and making such compositions.

### BACKGROUND OF THE INVENTION

Low pH laundry rinse compositions are known, see for example EP 3 650 523 Bl. Low pH laundry rinse compositions can provide freshness and malodour benefits to the treated fabrics, among other benefits.

Such compositions may include relatively high levels of citric acid and/or related salts. Fragrance materials (e.g., perfume) may also be added to the compositions in order to improve the neat product odor and/or to provide freshness benefits to the target fabrics upon treatment.

There is a need for improved low-pH fabric care compositions that provide freshness and malodour benefits even after the fabrics have been laundered, i.e, during store and during use of the fabrics. This is especially relevant when the fabrics are worn in situations prone to malodor generation, such as during exercise.

### SUMMARY OF THE INVENTION

The present disclosure relates to acidic fabric care compositions that include organic acid, preferably citric acid, Bacillus spores, and a fragrance material.

For example, the present disclosure relates to a liquid fabric care composition that includes: from about 10% to about 50%, by weight of the liquid fabric care composition, of an organic acid, preferably citric acid and/or a salt thereof; Bacillus spores, a fragrance material; and from about 30% to about 90%, by weight of the liquid fabric care composition, of water; where the composition includes less than 10%, by weight of the liquid fabric care composition, of a material selected from the group consisting of detersive surfactant, bleaching systems, fabric softening materials, and mixtures thereof; where the liquid fabric care composition has a neat pH of from about 2 to about 4.

For example, the present disclosure also relates to a powder fabric care composition that includes: an organic acid, preferably citric acid and/or a salt thereof; Bacillus spores, and a fragrance material; where the composition includes less than 10%, by weight of the powder fabric care composition, of a material selected from the group consisting of detersive surfactant, bleaching systems, fabric softening materials, and mixtures thereof; where the powder fabric care composition has a pH of from about 2 to about 4 as measured in a 1% weight aqueous solution at 25° C.

The present disclosure also relates to a method of treating a fabric, which includes the step of contacting the fabric with a composition according to the present disclosure.

The present disclosure also relates to a method of making a liquid fabric care composition, which includes combining water, citric acid, and a fragrance material, preferably wherein the fragrance material is premixed with nonionic surfactant.

### DETAILED DESCRIPTION OF THE INVENTION

The present disclosure relates to acidic fabric care compositions. The compositions include organic acid, fragrance material, and Bacillus spores. Such compositions are believed to provide good freshness and malodor removal to fabrics during the laundry process and also to prevent malodors after the fabric has been laundered, when the fabric is stored and when the fabric is in use.

It has been surprisingly found that Bacillus spores are stable and do not germinate in the liquid fabric care composition or in the laundry process however, they germinate faster after the laundry process and this seems to be associated to the tight pH range of the compositions of the invention. Compositions with pH lower than 2 seem to negatively affect spore stability in the product and in the rinse liquor during the laundry process. Compositions with pH higher than 4 seem to slow down the germination of the spores after the washing process.

Without wishing to be bound by theory, it is believed that exposure of the Bacillus spores to this tight pH range modifies their surface chemistry in a way that increases their sensitivity to small molecule germinants, perhaps by priming the germinant receptors or making them more accessible. At lower pH ranges these effects are believed to be overshadowed by significant damage to the spore surfaces with consequent loss of their viability to germinate. It has been found that the Bacillus spores are stable in the product of the invention. At the same time the Bacillus spores seem to become ‘primed’ in the composition. The ‘primed’ Bacillus spores can germinate and outgrow into metabolically active bacterial cells faster when stored or exposed to the composition of the invention as compared to Bacillus spores in compositions at pH 5-7. This is a desirable effect. During the rinse cycles the ‘primed’ Bacillus spores deposit on the fabric and become later on activated by available nutrients (e.g., body sweat) and malodor precursors (e.g., in residue soil) during wear or use.

The prevention of unwanted germination and outgrowth is desirable 1) in the product to prevent product stability failures and, 2) in the rinse cycle, where premature germination may negatively impact the spore deposition profile on fabrics. Germinated spores are not as robust as dormant spores, and they may be impacted by mechanical forces during the rinse cycle such as agitation and spinning.

The compositions and related methods are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening compositions, fabric enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, detergent contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation. Preferably, the compositions of the invention are added during the rinse cycle of the laundering operation.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Composition

The present disclosure relates to fabric care compositions that have a relatively low pH. Put another way, the present disclosure relates to acidic, fabric care compositions. The compositions can be in liquid or solid form.

The compositions of the present disclosure may be particularly useful for treating fabrics, such as garments or towels, during the rinse cycle of an automatic washing machine. Due to the low pH of the compositions, they can be useful for softening fabrics and/or for rejuvenating colors by removing limescale that may have accumulated on the fabrics, which can result from washing one's fabrics in hard water. The compositions of the invention provide freshness and malodor removal from fabrics during the laundering process and thereafter. The compositions of the invention can also provide malodor prevention.

The compositions comprise and organic acid preferably selected from the group consisting of citric acid, acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid, or mixtures thereof, preferably citric acid. It may be preferred that the composition is substantially free of an additional organic acid. It may be preferred that the composition is substantially free of acetic acid, which can add undesirable odors. In particular, it is preferred that the composition does not comprise 2.80% by weight of the composition of vinegar. For the purpose of this invention the term “vinegar” means any aqueous solution comprising from 5 to 8% by weight of the composition of acetic acid.

Preferably the composition comprises citric acid and/or a salt thereof. As one of ordinary skill will realize, the citric acid and a salt thereof may exist in an equilibrium in the liquid composition. Citric acid is preferred for use in the present compositions due to being both a performance-efficient and cost-efficient material, as well as being readily available, biobased and biodegradable.

The compositions may comprise from about 10% to about 50%, by weight of the liquid fabric care composition, of citric acid and/or a salt thereof. The liquid fabric care composition may comprise from about 15% to about 40%, preferably from about 20% to about 30%, by weight of the liquid fabric care composition, of the citric acid and/or the salt thereof.

The compositions of the present disclosure may also comprise bacterial spores. The spores are not deactivated by heat at the temperatures found in a washing machine. The spores are fabric-substantive and provide malodor control after the laundry process and also when the fabrics are in use (e.g. wearing).

The microbial spores of the method and compositions of the invention can germinate on fabrics. The spores can be activated by heat, for example, heat generated during use of the fabric or by the heat provided in the washing machine. The spores can germinate when the fabrics are stored and/or used. Malodor precursors can be used by the bacteria produced by the spores as nutrients promoting germination. The spores can also contribute to malodor prevention.

The bacterial spores for use herein: i) are capable of surviving the temperatures found in a typical laundry process; ii) are fabric substantive; and iii) have the ability to control odor. The spores have the ability to be stable in the fabric care compositions and germinate after the laundry process. They germinate and form cells on the fabrics using malodor precursors and probably organic acid residues as nutrients. The spores can be delivered in liquid or solid form. Preferably, the spores are in solid form.

Some gram-positive bacteria have a two-stage lifecycle in which growing bacteria under certain conditions such as in response to nutritional deprivation can undergo an elaborate developmental program leading to spores or endospores formation. The bacterial spores are protected by a coat consisting of about 60 different proteins assembled as a biochemically complex structure with intriguing morphological and mechanical properties. The protein coat is considered a static structure that provides rigidity and mainly acting as a sieve to exclude exogenous large toxic molecules, such as lytic enzymes. Spores play critical roles in long term survival of the species because they are highly resistant to extreme environmental conditions. Spores are also capable of remaining metabolically dormant for years. Methods for obtaining bacterial spores from vegetative cells are well known in the field. In some examples, vegetative bacterial cells are grown in liquid medium. Beginning in the late logarithmic growth phase or early stationary growth phase, the bacteria may begin to sporulate. When the bacteria have finished sporulating, the spores may be obtained from the medium, by using centrifugation for example. Various methods may be used to kill or remove any remaining vegetative cells. Various methods may be used to purify the spores from cellular debris and/or other materials or substances. Bacterial spores may be differentiated from vegetative cells using a variety of techniques, like phase-contrast microscopy, automated scanning microscopy, high resolution atomic force microscopy or tolerance to heat, for example. Because bacterial spores are generally environmentally-tolerant structures that are metabolically inert or dormant, they are readily chosen to be used in commercial microbial products. Despite their ruggedness and extreme longevity, spores can rapidly respond to the presence of small specific molecules known as germinants that signal favorable conditions for breaking dormancy through germination, an initial step in the process of completing the lifecycle by returning to vegetative bacteria. For example, the commercial microbial products may be designed to be dispersed into an environment where the spores encounter the germinants present in the environment to germinate into vegetative cells and perform an intended function. A variety of different bacteria may form spores. Bacteria from any of these groups may be used in the compositions, methods, and kits disclosed herein. For example, some bacteria of the following genera may form spores: Acetonema, Alkalibacillus, Ammoniphilus, Amphibacillus, Anaerobacter, Anaerospora, Aneurinibacillus, Anoxybacillus, Bacillus, Brevibacillus, Caldanaerobacter, Caloramator, Caminicella, Cerasibacillus, Clostridium, Clostridiisalibacter, Cohnella, Dendrosporobacter, Desulfotomaculum, Desulfosporomusa, Desulfosporosinus, Desulfovirgula, Desulfunispora, Desulfurispora, Filifactor, Filobacillus, Gelria, Geobacillus, Geosporobacter, Gracilibacillus, Halonatronum, Heliobacterium, Heliophilum, Laceyella, Lentibacillus, Lysinibacillus, Mahella, Metabacterium, Moorella, Natroniella, Oceanobacillus, Orenia, Ornithinibacillus, Oxalophagus, Oxobacter, Paenibacillus, Paraliobacillus, Pelospora, Pelotomaculum, Piscibacillus, Planifilum, Pontibacillus, Propionispora, Salinibacillus, Salsuginibacillus, Seinonella, Shimazuella, Sporacetigenium, Sporoanaerobacter, Sporobacter, Sporobacterium, Sporohalobacter, Sporolactobacillus, Sporomusa, Sporosarcina, Sporotalea, Sporotomaculum, Syntrophomonas, Syntrophospora, Tenuibacillus, Tepidibacter, Terribacillus, Thalassobacillus, Thermoacetogenium, Thermoactinomyces, Thermoalkalibacillus, Thermoanaerobacter, Thermoanaeromonas, Thermobacillus, Thermoflavimicrobium, Thermovenabulum, Tuberibacillus, Virgibacillus, and/or Vulcanobacillus.

Preferably, the bacteria that may form spores are from the family Bacillaceae, such as species of the genera Aeribacillus, Aliibacillus, Alkalibacillus, Alkalicoccus, Alkalihalobacillus, Alkalilactibacillus, Allobacillus, Alteribacillus, Alteribacter, Amphibacillus, Anaerobacillus, Anoxybacillus, Aquibacillus, Aquisalibacillus, Aureibacillus, Bacillus, Caldalkalibacillus, Caldibacillus, Calditerricola, Calidifontibacillus, Camelliibacillus, Cerasibacillus, Compostibacillus, Cytobacillus, Desertibacillus, Domibacillus, Ectobacillus, Evansella, Falsibacillus, Ferdinandcohnia, Fermentibacillus, Fictibacillus, Filobacillus, Geobacillus, Geomicrobium, Gottfriedia, Gracilibacillus, Halalkalibacillus, Halobacillus, Halolactibacillus, Heyndrickxia, Hydrogenibacillus, Lederbergia, Lentibacillus, Litchfieldia, Lottiidibacillus, Margalitia, Marinococcus, Melghiribacillus, Mesobacillus, Metabacillus, Microaerobacter, Natribacillus, Natronobacillus, Neobacillus, Niallia, Oceanobacillus, Ornithinibacillus, Parageobacillus, Paraliobacillus, Paralkalibacillus, Paucisalibacillus, Pelagirhabdus, Peribacillus, Piscibacillus, Polygonibacillus, Pontibacillus, Pradoshia, Priestia, Pseudogracilibacillus, Pueribacillus, Radiobacillus, Robertmurraya, Rossellomorea, Saccharococcus, Salibacterium, Salimicrobium, Salinibacillus, Salipaludibacillus, Salirhabdus, Salisediminibacterium, Saliterribacillus, Salsuginibacillus, Sediminibacillus, Siminovitchia, Sinibacillus, Sinobaca, Streptohalobacillus, Sutcliffiella, Swionibacillus, Tenuibacillus, Tepidibacillus, Terribacillus, Terrilactibacillus, Texcoconibacillus, Thalassobacillus, Thalassorhabdus, Thermolongibacillus, Virgibacillus, Viridibacillu, Vulcanibacillus, Weizmannia. In various examples, the bacteria may be strains of Bacillus Bacillus acidicola, Bacillus aeolius, Bacillus aerius, Bacillus aerophilus, Bacillus albus, Bacillus altitudinis, Bacillus alveayuensis, Bacillus amyloliquefaciensex, Bacillus anthracis, Bacillus aquiflavi, Bacillus atrophaeus, Bacillus australimaris, Bacillus badius, Bacillus benzoevorans, Bacillus cabrialesii, Bacillus canaveralius, Bacillus capparidis, Bacillus carboniphilus, Bacillus cereus, Bacillus chungangensis, Bacillus coahuilensis, Bacillus cytotoxicus, Bacillus decisifrondis, Bacillus ectoiniformans, Bacillus enclensis, Bacillus fengqiuensis, Bacillus fungorum, Bacillus glycinifermentans, Bacillus gobiensis, Bacillus halotolerans, Bacillus haynesii, Bacillus horti, Bacillus inaquosorum, Bacillus infantis, Bacillus infernus, Bacillus isabeliae, Bacillus kexueae, Bacillus licheniformis, Bacillus luti, Bacillus manusensis, Bacillus marinisedimentorum, Bacillus mesophilus, Bacillus methanolicus, Bacillus mobilis, Bacillus mojavensis, Bacillus mycoides, Bacillus nakamurai, Bacillus ndiopicus, Bacillus nitratireducens, Bacillus oleivorans, Bacillus pacificus, Bacillus pakistanensis, Bacillus paralicheniformis, Bacillus paramycoides, Bacillus paranthracis, Bacillus pervagus, Bacillus piscicola, Bacillus proteolyticus, Bacillus pseudomycoides, Bacillus pumilus, Bacillus safensis, Bacillus salacetis, Bacillus salinus, Bacillus salitolerans, Bacillus seohaeanensis, Bacillus shivajii, Bacillus siamensis, Bacillus smithii, Bacillus solimangrovi, Bacillus songklensis, Bacillus sonorensis, Bacillus spizizenii, Bacillus spongiae, Bacillus stercoris, Bacillus stratosphericus, Bacillus subtilis, Bacillus swezeyi, Bacillus taeanensis, Bacillus tamaricis, Bacillus tequilensis, Bacillus thermocloacae, Bacillus thermotolerans, Bacillus thuringiensis, Bacillus tianshenii, Bacillus toyonensis, Bacillus tropicus, Bacillus vallismortis, Bacillus velezensis, Bacillus wiedmannii, Bacillus wudalianchiensis, Bacillus xiamenensis, Bacillus xiapuensis, Bacillus zhangzhouensis, or combinations thereof.

In some examples, the bacterial strains that form spores may be strains of Bacillus, including: Bacillus sp. strain SD-6991; Bacillus sp. strain SD-6992; Bacillus sp. strain NRRL B-50606; Bacillus sp. strain NRRL B-50887; Bacillus pumilus strain NRRL B-50016; Bacillus amyloliquefaciens strain NRRL B-50017; Bacillus amyloliquefaciens strain PTA-7792 (previously classified as Bacillus atrophaeus); Bacillus amyloliquefaciens strain PTA-7543 (previously classified as Bacillus atrophaeus); Bacillus amyloliquefaciens strain NRRL B-50018; Bacillus amyloliquefaciens strain PTA-7541; Bacillus amyloliquefaciens strain PTA-7544; Bacillus amyloliquefaciens strain PTA-7545; Bacillus amyloliquefaciens strain PTA-7546; Bacillus subtilis strain PTA-7547; Bacillus amyloliquefaciens strain PTA-7549; Bacillus amyloliquefaciens strain PTA-7793; Bacillus amyloliquefaciens strain PTA-7790; Bacillus amyloliquefaciens strain PTA-7791; Bacillus subtilis strain NRRL B-50136 (also known as DA-33R, ATCC accession No. 55406); Bacillus amyloliquefaciens strain NRRL B-50141; Bacillus amyloliquefaciens strain NRRL B-50399; Bacillus licheniformis strain NRRL B-50014; Bacillus licheniformis strain NRRL B-50015; Bacillus amyloliquefaciens strain NRRL B-50607; Bacillus subtilisstrain NRRL B-50147 (also known as 300R); Bacillus amyloliquefaciens strain NRRL B-50150; Bacillus amyloliquefaciens strain NRRL B-50154; Bacillus megaterium PTA-3142; Bacillus amyloliquefaciens strain ATCC accession No. 55405 (also known as 300); Bacillus amyloliquefaciens strain ATCC accession No. 55407 (also known as PMX); Bacillus pumilus NRRL B-50398 (also known as ATCC 700385, PMX-1, and NRRL B-50255); Bacillus cereus ATCC accession No. 700386; Bacillus thuringiensis ATCC accession No. 700387 (all of the above strains are available from Novozymes, Inc., USA); Bacillus amyloliquefaciens FZB24 (e.g., isolates NRRL B-50304 and NRRL B-50349 TAEGRO® from Novozymes), Bacillus subtilis (e.g., isolate NRRL B-21661 in RHAPSODY®, SERENADE® MAX and SERENADE® ASO from Bayer CropScience), Bacillus pumilus (e.g., isolate NRRL B-50349 from Bayer CropScience), Bacillus amyloliquefaciens TrigoCor (also known as “TrigoCor 1448”; e.g., isolate Embrapa Trigo Accession No. 144/88.4Lev, Cornell Accession No. Pma007BR-97, and ATCC accession No. 202152, from Cornell University, USA) and combinations thereof.

In some examples, the bacterial strains that form spores may be strains of Bacillus amyloliquefaciens. For example, the strains may be Bacillus amyloliquefaciens strain PTA-7543 (previously classified as Bacillus atrophaeus), and/or Bacillus amyloliquefaciens strain NRRL B-50154, Bacillus amyloliquefaciens strain PTA-7543 (previously classified as Bacillus atrophaeus), Bacillus amyloliquefaciens strain NRRL B-50154, or from other Bacillus amyloliquefaciens organisms.

In some examples, the bacterial strains that form spores may be Brevibacillus spp., e.g., Brevibacillus brevis; Brevibacillus formosus; Brevibacillus laterosporus; or Brevibacillus parabrevis, or combinations thereof.

In some examples, the bacterial strains that form spores may be Paenibacillus spp., e.g., Paenibacillus alvei; Paenibacillus amylolyticus; Paenibacillus azotofixans; Paenibacillus cookii; Paenibacillus macerans; Paenibacillus polymyxa; Paenibacillus validus, or combinations thereof. The bacterial spores may have an average particle diameter of about 0.5 to 50 or from 2 to 50 microns or from 10 to 45 microns or from 0.5-6 microns, suitably about 1-5 microns. Bacillus spores are commercially available in blends in aqueous carriers and are insoluble in the aqueous carriers. Other commercially available bacillus spore blends include without limitation Freshen Free™ CAN (10×), available from Novozymes Biologicals, Inc.; Evogen® Renew Plus (10×), available from Genesis Biosciences, Inc.; and Evogen® GT (10×, 20× and 110×), all available from Genesis Biosciences, Inc. In the foregoing list, the parenthetical notations (10×, 20×, and 110×) indicate relative concentrations of the Bacillus spores.

Bacterial spores used in the compositions, methods, and products disclosed herein may or may not be heat activated. In some examples, the bacterial spores are heat activated. In some examples, the bacterial spores are not heat inactivated. Preferably, the spores used herein are heat activated. Heat activation may comprise heating bacterial spores from room temperature (15-25° C.) to optimal temperature of between 25-120° C., preferably between 40 C-100° C., and held the optimal temperature for not more than 2 hours, preferably between 70-80° C. for 30 min.

For the methods, compositions and products disclosed herein, populations of bacterial spores are generally used. In some examples, a population of bacterial spores may include bacterial spores from a single strain of bacterium. Preferably, a population of bacterial spores may include bacterial spores from 2, 3, 4, 5, or more strains of bacteria. Generally, a population of bacterial spores contains a majority of spores and a minority of vegetative cells. In some examples, a population of bacterial spores does not contain vegetative cells. In some examples, a population of bacterial spores may contain less than about 1%, 2%, 3%, 4%, 5%, 6%, 7%, 8%, 9%, 10%, 15%, 20%, 25%, 30%, 40%, or 50% vegetative cells, where the percentage of bacterial spores is calculated as ((vegetative cells/(spores in population+vegetative cells in population))×100). Generally, populations of bacterial spores used in the disclosed methods, compositions and products are stable (i.e. not undergoing germination), with at least some individual spores in the population capable of germinating.

Populations of bacterial spores used in this disclosure may contain bacterial spores at different concentrations. In various examples, populations of bacterial spores may contain, without limitation, at least 1×10², 5×10², 1×10³, 5×10³, 1×10⁴, 5×10⁴, 1×10⁵, 5×10⁵, 1×10⁶, 5×10⁶, 1×10⁷, 5×10⁷, 1×10⁸, 5×10⁸, 1×10⁹, 5×10⁹, 1×10¹⁰, 5×10¹⁰, 1×10¹¹, 5×10¹¹, 1×10¹², 5×10¹², 1×10¹³, 5×10¹³, 1×10¹⁴, or 5×10¹⁴ spores/ml, spores/gram, or spores/cm³.

The compositions of the present disclosure may also comprise a first sulfur-containing compound. The first sulfur-containing compound is preferably selected from a sulfate compound, a bisulfate compound, or a combination thereof. It has been found that the presence of a sulfate or bisulfate compound can reduce color instability in the compositions of the present disclosure, particularly in the presence of perfume.

The composition may comprise from about 0.001% to about 1.0%, by weight of the liquid fabric care composition, of the first sulfur-containing compound, which is preferably selected from a sulfate compound, a bisulfate compound, or a combination thereof. The liquid fabric care composition may comprise from about 0.003% to about 0.1%, by weight of the liquid fabric care composition, of the sulfur-containing compound, preferably from about 0.003% to about 0.01%. Rather than a percentage, the amounts may be expressed as parts per million, or “ppm”, by weight. For example, the composition may comprise from about 10 ppm to about 10,000 ppm, preferably from about 30 ppm to about 1000 ppm, more preferably from about 30 ppm to about 100 ppm of the sulfur-containing compound.

The sulfur-containing compound is preferably selected from the group consisting of an alkali metal sulfate, an alkali metal bisulfate, an alkaline earth metal sulfate, an alkaline earth metal bisulfate, and combinations thereof. Preferably, the sulfur-containing compound is selected from the group consisting of an alkali metal sulfate, an alkali metal bisulfate, sulfuric acid, and combinations thereof. It is even more preferred that the sulfur-containing compound comprises an alkali metal bisulfate, more preferably sodium bisulfate. Such materials are both effective and readily available.

The sulfate-containing compound is preferably an inorganic sulfur-containing compound (e.g., sodium bisulfate). Inorganic sulfates and bisulfates are readily available, and can easily be incorporated into the liquid compositions of the present disclosure, for example by dissolving.

The sulfur-containing compound is preferably not a surfactant, preferably not an alkyl sulfate or an alkoxylated alkyl sulfate. Surfactants such as these may not provide the same color stability benefits as the preferred sulfates, and/or may undesirably adhere to fabrics, particularly when the composition is used in a rinse cycle.

The liquid fabric care compositions of the present disclosure comprise a fragrance material (also herein “fragrance” or “perfume”). The fragrance materials are added to provide aesthetically pleasing scent to the liquid product composition, to a treatment liquor, and/or to fabrics treated with the composition. The compositions of the present disclosure may include from about 0.1% to about 20%, or from about 0.2% to about 10%, or from about 0.3% to about 5%, by weight of the composition, of fragrance materials.

Non-limiting examples of fragrance materials include, but are not limited to, aldehydes, ketones, esters, and the like. Other examples include various natural extracts and essences which can comprise complex mixtures of ingredients, such as orange oil, lemon oil, rose extract, lavender, musk, patchouli, balsamic essence, sandalwood oil, pine oil, cedar, and the like. Finished perfumes can comprise extremely complex mixtures of such ingredients.

The fragrance material may comprise aldehydic perfume raw materials. Without wishing to be bound by theory, it is believed that while aldehydic perfume raw materials are often desirable from an olfactory/freshness point of view, they may also have a tendency to discolor. Thus, via the inclusion of sulfate or bisulfate compounds that mitigate color instability, such aldehydic materials may more conveniently be used in the fabric care compositions of the present disclosure.

The aldehydic perfume raw materials may be present at a level of from about 5% to about 75%, preferably from about 10% to about 50%, by weight of the fragrance material.

Suitable aldehydic perfume raw materials may include: methyl nonyl acetaldehyde: benzaldehyde; floralozone; isocyclocitral; triplal (ligustral); precyclemone B; lilial; decyl aldehyde; undecylenic aldehyde; cyclamen homoaldehyde; cyclamen aldehyde; dupical; oncidal; adoxal; melonal; calypsone; anisic aldehyde; heliotropin; cuminic aldehyde; scentenal; 3,6-dimethylcyclohex-3-ene-1-carbaldehyde; satinaldehyde; canthoxal; vanillin; ethyl vanillin; cinnamic aldehyde; cis-4-decenal; trans-4-decenal; cis-7-decenal; undecylenic aldehyde; trans-2-hexenal; trans-2-octenal; 2-undecenal; 2,4-dodecadeienal; cis-4-heptenal; Florydral; butyl cinnamaldehyde; limonelal; amyl cinnamaldehyde; hexyl cinnamaldehyde; citronellal; citral; cis-3-hexen-1-al; or mixtures thereof.

At least a portion of the fragrance materials of the present disclosure may be derived from naturally sourced materials. It is believed that such materials have a lesser environmental impact and/or are more environmentally sustainable compared to synthetically derived and/or geologically derived (such as petroleum-based) materials. At least about 50%, or at least about 60%, or at least about 70%, or at least about 80%, or at least about 90%, or at least about 95%, or about 100%, by weight of the fragrance materials, of the fragrance materials may be naturally derived fragrance materials.

For the fabric treatment compositions of the present disclosure, it is desirable for the fragrance materials to be relatively hydrophilic. Hydrophilic fragrance materials are more likely to adequately dissolve or disperse in the aqueous compositions of the present disclosure, leading to improved phase stability and/or product transparency.

Because the compositions of the present disclosure are typically characterized by a relatively low pH, the fragrance materials of the present disclosure are typically acid-stable, particularly at the pH of the composition. Acid stability may qualitatively be shown by the lack of phase separation, a lack of discoloration, and/or a lack of precipitate formation at an acidic pH upon storage, preferably at a pH of from about 2 to about 4.

To facilitate convenient incorporation of the fragrance material into the aqueous compositions of the present disclosure, the fragrance material may be mixed with a nonionic surfactant or other emulsifier prior to being mixed with the water and/or citric acid. Put another way, the composition may be made by a process in which the fragrance material is mixed with nonionic surfactant prior to being mixed with the citric acid.

The liquid fabric care compositions of the present disclosure are typically aqueous compositions. The liquid fabric care compositions typically comprise water. The compositions may comprise from about 30% to about 90%, by weight of the liquid fabric care composition, of water. The composition may comprise from about 50% to about 90% water, preferably from about 60% to about 85%, more preferably from about 70% to about 80%, by weight of the liquid fabric care composition.

The liquid fabric treatment compositions of the present disclosure are aqueous, the compositions may further comprise organic solvent, which can improve composition stability, ingredient dissolution, and/or transparency of the composition. The fabric treatment compositions may include from about 0.1% to about 30%, or from about 1% to about 20%, by weight of the composition, of organic solvent. Suitable organic solvents may include ethanol, diethylene glycol (DEG), 2-methyl-1,3-propanediol (MPD), monopropylene glycol (MPG), dipropylene glycol (DPG), oligamines (e.g., diethylenetriamine (DETA), tetraethylenepentamine (TEPA)), glycerine, propoxylated glycerine, ethoxylated glycerine, ethanol, 1,2-propanediol (also referred to as propylene glycol), 1,3-propanediol, 2,3-butanediol, cellulosic ethanol, renewable propylene glycol, renewable monopropylene glycol, renewable dipropylene glycol, renewable 1,3-propanediol, and mixtures thereof. One or more of the organic solvents may be bio-based, meaning that they are derived from a natural/sustainable, non-geologically-derived (e.g., non-petroleum-based) source. Preferably, the liquid composition of the invention comprises 1, 2-propanediol.

The liquid fabric care compositions of the present disclosure may comprise a hydrotrope, such as sodium cumene sulphonate (SCS), which may help with the stability of the composition.

The liquid compositions of the present disclosure may comprise nonionic surfactant, which may help with product stability and/or incorporation of the fragrance materials. The composition may comprise from about 0.1 to about 8%, preferably from about 1% to about 5%, by weight of the liquid fabric care composition, of nonionic surfactant. The nonionic surfactant is preferably an ethoxylated fatty alcohol. The nonionic surfactant may be premixed with the fragrance materials.

The liquid fabric care compositions of the present disclosure are acidic compositions. A low pH is believed to facilitate the benefits provided (e.g., limescale removal) by the present compositions. For example, the composition may be characterized by a neat pH of from about 2 to about 4, more preferably from about 2 to about 3. These ranges of pH are believed to provide stability of the spores in the composition and in use and faster germination of the spores after the product has been used.

The compositions of the present disclosure may comprise a neutralizing agent, which can aid in achieving a desired pH. The neutralizing agent is preferably a caustic neutralizing agent, more preferably sodium hydroxide (NaOH). It is believed that strong bases, such as caustic neutralizing agents like NaOH, can provide physical stability benefits relative to weak bases, such as monoethanolamine (MEA).

The liquid fabric care compositions of the present disclosure may comprise a limited number of ingredients, for example, no more than ten, or no more than nine, or no more than eight, or no more than seven, or no more than six, or no more than five ingredients. Limiting the number of ingredients can result in lower storage and/or transportation costs of raw materials, and/or simplify the process of making the compositions. Consumers may also desire products having a limited number of ingredients, as they may be perceived as simpler, as having a smaller environmental footprint, and/or as providing an easier-to-understand ingredient list.

The liquid fabric care composition may comprise less than 10%, by weight of the liquid fabric care composition, of a material selected from the group consisting of detersive surfactant, bleaching systems, fabric softening materials, and mixtures thereof. The composition may comprise less than 8%, preferably less than 5%, preferably less than 4%, preferably less than 2.5%, preferably less than 1%, or even is substantially free of a material selected from the group consisting of detersive surfactant, bleaching systems, and/or fabric softening materials. Such materials may affect the aesthetics, physical stability, and/or chemical stability of the other ingredients in the present compositions. Additionally or alternatively, certain such materials may not be physically or chemically stable themselves in low-pH environment of the present compositions. Furthermore, consumers who use the present compositions may be hoping to remove materials from their treated fabrics, whereas at least some of the listed materials may instead deposit on fabric during a normal treatment cycle, building up undesirable residues.

The present compositions may be substantially free of detersive surfactants, including anionic, amphoteric, and/or zwitterionic surfactants. Anionic surfactants may include: sulfated surfactants, such as alkyl sulfate or alkoxylated alkyl sulfate; sulfonated surfactants, such as (linear) alkyl benzene sulfonates; and/or carboxylated surfactants. Nonionic surfactants may include: alkoxylated fatty alcohols; alkoxylated alkyl phenols; and/or alkyl polyglucosides. Zwitterionic surfactants may include amine oxide and/or betaines.

The liquid fabric care composition may comprise less than 5%, preferably less than 3%, more preferably less than 1%, even more preferably less than 0.1%, by weight of the composition, of anionic surfactant.

As mentioned above, the liquid fabric care composition may comprise nonionic surfactant. When the composition comprises a nonionic surfactant, the composition may be substantially free of other (non-nonionic) surfactants.

The present compositions may be substantially free of bleaching systems. Bleaching systems may include peroxide bleaches, such as hydrogen peroxide and/or sources of peroxide. Bleaching systems may include hypohalite bleaches, such as hypochlorite bleaches, or sources of such hypohalites. Bleaching systems may also include bleach activators, such as NOBS or TAED, or bleach catalysts.

The present compositions may be substantially free of fabric softening materials. Such materials may deposit on fabric, which may be less preferred for certain consumers, applications, or fabrics. Additionally or alternatively, such materials may require emusification or other processing to make them compatible with the present aqueous compositions. Fabric softening materials may be cationically charged and/or capable of becoming cationically charged in typical wash conditions. Fabric softening materials may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof. As used herein, the terms “fabric softening materials” is not intended to include any of the materials listed in the “Organic Acid(s)” section above.

A preferred liquid fabric care composition comprises:
i) from 15% to 35%, by weight of the liquid fabric care composition, of citric acid and/or a salt thereof;
ii) from about 1×10³ to about 1×10⁸ CFU/ml of the composition of Bacillus spores;
iii) from 0.1% to 5%, by weight of the liquid fabric care composition, of the fragrance material wherein the fragrance material comprises from 5% to 75% by weight of the fragrance material of aldehydic perfume raw materials; and
iv) from 30% to 90%, by weight of the liquid fabric care composition, of water;
wherein the composition comprises less than 5%, by weight of the liquid fabric care composition, of a material selected from the group consisting of detersive surfactant, bleaching systems, fabric softening materials, and mixtures thereof.

A preferred liquid fabric care composition comprises:
i) from 15% to 35%, by weight of the liquid fabric care composition, of citric acid and/or a salt thereof;
ii) from about 1×10² to about 1×10⁹ CFU/ml, 1×10³ to about 1×10⁸ CFU/ml of the composition of Bacillus spores;
iii) from 0.1% to 5%, by weight of the liquid fabric care composition, of the fragrance material wherein the fragrance material comprises from 5% to 75% by weight of the fragrance material of aldehydic perfume raw materials; and
iv) from 30% to 90%, by weight of the liquid fabric care composition, of water;
v) from 0.1% to 8%, by weight of the liquid fabric care composition, of nonionic surfactant;
vi) optionally a hydrotrope, preferably sodium cumene sulfonate; and
   wherein the composition comprises less than 5%, by weight of the liquid fabric care composition, of a material selected from the group consisting of detersive surfactant, bleaching systems, fabric softening materials, and mixtures thereof.

The liquid fabric care compositions of the present disclosure may be relatively transparent. For example, the composition may be characterized by a percent transmittance (% T) of at least about 60% of light using a one-centimeter cuvette, at a wavelength of about 410-800 nanometers when the composition is substantially free of dyes.

As described above, the present compositions may be relatively transparent. Therefore, the present composition may be substantially free of particles, such as encapsulated benefit agents, silicone droplets, pearlescent agents, and/or opacifiers, which may reduce the relative transparency of the composition. The present compositions may be substantially free of optical brighteners. The present compositions may be substantially free of dyes. As used herein the term “dye” includes aesthetic dyes that modify the aesthetics of the cleaning composition as well as dyes and/or pigments that can deposit onto a fabric and alter the tint of the fabric. Dyes are intended to include colorants, pigments, and hueing agents. Depending on the desired application or aesthetics, the composition may comprise dye, preferably an aesthetic dye.

The liquid fabric care compositions of the present disclosure may be characterized by a relatively low viscosity. Such viscosities may be desirable for convenient pouring and/or little hang-up in a machine's dispenser drawer. The composition may be characterized by a viscosity of from about from about 0 to about 200 cps, preferably from about 0 to about 100 cps, more preferably from about 0 to about 60 cps, as determined by rotational viscometry using a Brookfield viscometer and ASTM D 2196-99 at 60 RPM and 22° C.

In an effort to keep viscosity low, the compositions of the present disclosure may be substantially free of thickeners or other rheology enhancers, such as structurants. The compositions may be substantially free of salts, such as inorganic salts like sodium chloride, magnesium chloride, and/or calcium chloride, that can provide rheology modification such as thickening. As used herein, such salts are not intended to include the neutralization products of the organic acids described herein.

The liquid fabric care compositions described herein can be packaged in any suitable container, including those constructed from paper, cardboard, plastic materials, and any suitable laminates. The container may contain renewable and/or recyclable materials.

The compositions may be packaged in a transparent or translucent container. It may be preferred to package a transparent fabric care composition in a transparent or translucent container, such as a transparent or translucent bottle. The container may have a transmittance of more than about 25%, or more than about 30%, or more than about 40%, or more than about 50% in the visible part of the spectrum (approx. 410-800 nm). Alternatively, absorbency of the bottle may be measured as less than about 0.6 or by having transmittance greater than about 25%, where % transmittance equals:

$$\frac{1}{{10}^{absorbancy}} \times 100 \%$$

For purposes of this disclosure, as long as one wavelength in the visible light range has greater than about 25% transmittance, it is considered to be transparent/translucent.

Clear bottle materials that may be used include, but are not limited to: polypropylene (PP), polyethylene (PE), polycarbonate (PC), polyamides (PA) and/or polyethylene terephthalate (PETE), polyvinylchloride (PVC); and polystyrene (PS). Recyclable materials may be preferred for environmental reasons.

The container or bottle may be of any form or size suitable for storing and packaging liquids for household use. For example, the container may have any size but usually the container will have a maximal capacity of about 0.05 to about 15 L, or about 0.1 to about 5 L, or from about 0.2 to about 2.5 L. The container may be suitable for easy handling. For example, the container may have handle or a part with such dimensions to allow easy lifting or carrying the container with one hand. The container may have a means suitable for pouring a liquid detergent composition and means for reclosing the container. The pouring means may be of any size or form. The closing means may be of any form or size (e.g., to be screwed or clicked on the container to close the container). The closing means may be cap, which can be detached from the container. Alternatively, the cap may be attached to the container, whether the container is open or closed. The closing means may also be incorporated in the container.

A preferred composition is a solid composition, preferably in powder form, comprising:
i) an organic acid and/or a salt thereof;
ii) from about 1×10² to about 1×10⁹ CFU/g, preferably from 1×10³ to about 1×10⁸ CFU/g of the composition of Bacillus spores;
iii) a fragrance material preferably comprising aldehydic perfume raw materials;
   wherein the composition comprises less than 10%, by weight of the powder composition, of a material selected from the group consisting of detersive surfactant, bleaching systems, fabric softening materials, and mixtures thereof;
   wherein the composition is characterized by having a pH of from about 2 to about 4 as measured in a 1% weight aqueous solution at 20° C.

### Method of Treatment

The present disclosure relates to a method of treating a fabric. The method includes the step of contacting the fabric with a fabric care composition according to the present disclosure.

The contacting step may occur in the presence of water. The contacting step preferably occurs during a rinse cycle of an automatic washing machine.

The composition may be dispersed or dissolved in water, forming a treatment liquor. The pH of the treatment liquor may be slightly greater than the pH of the liquid fabric care composition. The treatment liquor may be characterized by a pH of from about 2, or from about 2.3, or from about 4.5, or to about 4, or to about 3.5. The organic acid of the fabric care composition may be selected so as to substantially buffer the treatment liquor to a desired pH. Additionally or alternatively, the fabric care composition may include other buffers or pH-balancing agents to deliver a desired pH in the treatment liquor.

The compositions are typically employed at concentrations of from about 500 ppm to about 15,000 ppm in solution (i.e., the treatment liquor).

The water temperature may range from about 5° C. to about 90° C., preferably from about 10° C. to about 40° C. The weight ratio of the treatment liquor to fabric may be from about 1:1 to about 30:1.

The process may be a manual process, such as in a wash basin, or it may be an automatic process, occurring the drum of an automatic laundry machine. The machine may be a top-loading machine or a front-loading machine. The compositions of the present disclosure may be manually provided to the drum of an automatic washing machine, or they may be automatically provided, for example via a dispenser drawer or other vessel.

Typical treatment processes include at least one wash cycle and at least one subsequent rinse cycle. Fabrics may be treated with surfactant, such as anionic surfactant, during the wash cycle. The composition may be preferably provided to the drum, and/or the fabrics may be contacted with the composition, during a rinse cycle.

### Method of Making

The present disclosure relates to a method of making a liquid fabric care composition as described herein. The method may include the step of combining water, citric acid and/or salts thereof, Bacillus spores, and a fragrance material, for example in amount suitable for obtaining the wt %'s described herein. Preferably, the fragrance material is premixed with nonionic surfactant. The other materials of the composition may be added independently, or it may come in with the citric acid.

Any suitable processes known in the art may be used, for example batch processes, in-line mixing, and/or circulation-loop-based processes.

The method of making may include the steps of: providing an aqueous base, which may simply be water; adding citric acid, which may be part of an aqueous solution, such as a 50% citric acid solution; and adding fragrance material, which may be premixed with nonionic surfactant. Other optional materials, such as neutralizing agent, hydrotrope, additional surfactant and/or solvent, may be added as desired.

The aqueous base may include water. The aqueous base may include at least 50%, or at least 60%, or at least 70%, or at least 75%, or at least 80%, or at least 85%, or at least 90%, or at least 95%, by weight of the aqueous base, of water.

### Combinations

Specifically contemplated combinations of the disclosure are herein described in the following lettered paragraphs. These combinations are intended to be illustrative in nature and are not intended to be limiting.
A. A liquid fabric care composition comprising:
   i) from 10% to 50%, by weight of the liquid fabric care composition, of an organic acid and/or a salt thereof;
   ii) from about 1×10² to about 1×10⁹ CFU/ml, preferably from about 1×10³ to about 1×10⁸ CFU/ml of the liquid fabric care composition, of Bacillus spores;
   iii) a fragrance material comprising aldehydic perfume raw materials, preferably from 10% to 50%, by weight of the fragrance material of aldehydic perfume raw materials; and
   iv) from 30% to 90%, by weight of the liquid fabric care composition, of water;
   wherein the composition comprises less than 10%, by weight of the liquid fabric care composition, of a material selected from the group consisting of detersive surfactant, bleaching systems, fabric softening materials, and mixtures thereof;
   wherein the liquid fabric care composition has a neat pH of from about 2 to about 4.
B. The liquid fabric care composition according to paragraph A, wherein the organic acid is selected from citric acid, acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid and/or a salt thereof and mixtures thereof, preferably citric acid and/or a salt thereof.
C. The liquid fabric care composition according to any of paragraphs A or B, wherein the liquid fabric care composition comprises from 12% to 40%, preferably from 15% to 30%, by weight of the liquid fabric care composition, of the citric acid and/or the salt thereof.
D. The liquid fabric care composition according to any of paragraphs A-C, wherein the liquid fabric care composition comprises from 0.001% to 1.0%, by weight of the liquid fabric care composition, of a first sulfur-containing compound selected from a sulfate compound, a bisulfate compound, or a combination thereof, preferably the sulfur-containing compound is selected from the group consisting of an alkali metal sulfate, an alkali metal bisulfate, an alkaline earth metal sulfate, an alkaline earth metal bisulfate, sulfuric acid, and combinations thereof,
   preferably selected from the group consisting of an alkali metal sulfate, an alkali metal bisulfate, sulfuric acid, and combinations thereof,
      more preferably selected from the group consisting of an alkali metal bisulfate,
         even more preferably wherein the sulfur-containing compound comprises sodium bisulfate.
E. The liquid fabric care composition according to any of paragraphs A-D, wherein the fragrance material comprises from 5% to 75%, preferably from 10% to 50%, by weight of the fragrance material of aldehydic perfume raw materials.
F. The liquid fabric care composition according to any of paragraphs A-E, wherein the liquid fabric care composition comprises from 0.1% to 10%, preferably from 0.2% to 5%, by weight of the composition, of the fragrance material.
G. The liquid fabric care composition according to any of paragraphs A-F, wherein the liquid fabric care composition comprises from 50% to 90% water, preferably from 60% to 85%, more preferably from 70% to 80%, by weight of the liquid fabric care composition.
H. The liquid fabric care composition according to any of paragraphs A-G, wherein the liquid fabric care composition comprises less than 8%, preferably less than 5%, preferably less than 4%, preferably less than 2.5%, preferably less than 1% by weight of the liquid fabric care composition, or even is substantially free of a material selected from the group consisting of detersive surfactant, bleaching systems, fabric softening materials, and combinations thereof.
I. The liquid fabric care composition according to any of paragraphs A-H, wherein the fabric care composition comprises from 0.1% to 8%, preferably from 1% to 5%, by weight of the liquid fabric care composition, of nonionic surfactant.
J. The liquid fabric care composition according to any of paragraphs A-I, wherein the neat fabric care composition has by a pH of from 2.3 to 3.7.
K. The liquid fabric care composition according to any of paragraphs A-J, wherein the liquid fabric care composition has a percent transmittance (% T) of at least 60% of light using a 1 centimeter cuvette, at a wavelength of 410-800 nanometers when the composition is substantially free of dyes.
L. The liquid fabric care composition according to any of paragraphs A-K, wherein the liquid fabric care composition has a viscosity of from 0 to 200 cps, preferably from 0 to 100 cps, more preferably from 0 to 60 cps, as determined by rotational viscometry using a Brookfield viscometer and ASTM D 2196-99 at 60 RPM and 22° C.
M. The liquid fabric care composition according to any of paragraphs A-L, wherein the liquid fabric care composition does not contain 2.80% by weight, of vinegar.
N. The liquid fabric care composition according to any of paragraphs A-M, wherein the liquid fabric care composition according to any preceding claim, wherein the composition comprises:
   i) from 15% to 35%, by weight, of citric acid and/or a salt thereof;
   ii) from about 1×10³ to about 1×10⁸ CFU/ml of the composition of Bacillus spores;
   iii) from 0.1% to 5%, by weight, of the fragrance material;
   iv) optionally from 0.1% to 5%, by weight, of a non-ionic surfactant; and from 30% to 90%, by weight, of water;
   wherein the composition comprises less than 5%, by weight, of a material selected from the group consisting of detersive surfactant, bleaching systems, fabric softening materials, and mixtures thereof.
O. The liquid fabric care composition according to according to any of paragraphs A-N, wherein the composition is packaged in a transparent or translucent container.
P. A process for making the composition of paragraph I, the process comprising the step of mixing the fragrance material with the nonionic surfactant prior to being mixed with the organic acid.

### Test Methods

### Method for Measuring pH

The pH of the liquid fabric care composition, or the diluted powder composition, is measured using a Extech Instrument Model pH300 pH probe, available from W. W. Grainger, Inc. Lake Forrest Illinois. The pH probe is first properly calibrated using pH buffer solutions of pH 1.68, pH 4.00, and pH 7.00. The probe is then used to measure the neat liquid acid rinse product with no product dilution. The sample is measured at a temperature of 20 C. The probe is rinsed with deionized water and carefully wiped clean and dried in between reading the pH of different samples.

### EXAMPLES

The examples provided below are intended to be illustrative in nature and are not intended to be limiting.

The germination times of Bacillus spores that had been in compositions according to the invention (SMP #1-3) were compared with the germination times of Bacillus spores in comparative compositions (SMP #4-6). The comparative compositions differ from the compositions of the invention only in the pH. The comparative compositions have higher pH. The Bacillus spores were extracted from the compositions and placed in a nutrient medium, Trypticase Soy Broth (TSB) to simulate the nutrients on soiled clothing during use.

### Method 1: Preparation of Bacillus Spores Working Suspension

The Bacillus spores were purified by transferring about 1 ml of Bacillus spores (Evozyme® P500 BS7, Genesis Biosciences, Cardiff) aseptically into sterile 15 mL Conical Centrifuge Tubes Cat. No. 430052 (VWR Int., West Chester, PA) with sterile serological disposable glass pipet, (5 mL Cat. No. 93000-696; VWR Int., West Chester, PA). To the lml Bacillus spore, 9 ml of de-ionised (DI) water (CAS no. 7732-18-5 ASTM Type II, VWR Chemicals BDH®) was added and mixed by vortexing on an VWR Mini Vortexer Model no. 945300 (VWR Int., West Chester, PA) for 10 seconds. The resulting suspension was pelletized by centrifugation at 3000 RPM for 3 minutes on Thermo Scientific Centrifuge, Cat No. 75004261 (Thermo Scientific, Germany) to form a Bacillus spore pellet at the bottom of the conical centrifuge tube. The supernatant was discarded, and the cleaned-up Bacillus spore pellet was reconstituted in 1 mL of DI water to form a Bacillus spore working suspension.

Liquid Fabric Care Composition for pH Range with Bacillus Spores

First, the liquid fabric care composition comprising the ingredients in the proportions listed in Table 1 was divided into six (6) equal samples (SMP) of about 20 ml to study a set of six (6) pH ranging from 2 to 7 in +1 pH point increments.

TABLE 1

| Liquid fabric care composition Ingredients | Composition 1 (wt %) |
|---|---|
| Citric Acid Solution¹ | 46.85% |
| Sodium Formate Solution² | 0.50% |
| Sodium Hydroxide Solution³ | 4.10% |
| Propylene Glycol⁴ | 5.29% |
| Sodium Cumenesulfonate Solution⁵ | 2.35% |
| NI C24-9⁶ | 0.11% |
| Perfume | 0.74% |
| Sodium Bisulfate | 0.048% (480 ppm) |
| Water | To 100% pH 2.72 |

¹50.5% active citric acid solution of food grade quality available from Tate and Lyle PLC, Dayton, Ohio
²30% active sodium formate solution created by mixing 30% by weight sodium formate powder, available from Perstorm Polyols Inc, Toledo, Kansas, with 70% by weight deionized water in an appropriately sized container used to contain the mixture.
³50% active sodium hydroxide solution membrane grade available from Formosa Plastics Corp, Baton Rouge, Louisiana
⁴Bio-sourced grade available from Archer Daniels Midland, Decatur, Illinois
⁵45% active sodium cumenesulfonate solution available from Nease Corp, Harrison, Ohio
⁶C12-C14 Alcohol ethoxylate with average nine moles of ethoxylation (C24-9). Available from Huntsman Corp, Port Neches, Texas

Secondly, the Bacillus spores prepared according to Method 1 were added to the samples (SMP #1 to SMP #6) listed in Table 2. The Bacillus spores prepared according to Method 1 were also added to control sample (SMP #7) that comprised deionized water at pH 7. The resulting pH of the solution was adjusted with 0.1N HCl (lot no. 19D0356453, VWR Chemicals BDH®) or 1.0N NaOH (Cat no. BDH322-1, VWR Chemicals BDH®) solutions to the desired final pH measured with a calibrated pH meter (Orion Star A221., Thermo Scientific).

TABLE 2

| | SMP #1 | SMP #2 | SMP #3 | SMP #4 | SMP #5 | SMP #6 | SMP #7 |
|---|---|---|---|---|---|---|---|
| | wt.-% | wt.-% | wt.-% | wt.-% | wt.-% | wt.-% | wt.-% |
| Composition 1 | 99.99% | 99.99% | 99.99% | 99.99% | 99.99% | 99.99% | — |
| Bacillus spore⁷ | 0.01% | 0.01% | 0.01% | 0.01% | 0.01% | 0.01% | 0.01% |
| Total | 100% | 100% | 100% | 100% | 100% | 100% | 100% |
| pH adjusted in | 2.01 ± 0.02 | — | — | — | — | — | — |
| 0.1N HCl | | | | | | | |
| pH adjusted in | — | 3.00 ± 0.02 | 4.00 ± 0.02 | 5.00 ± 0.02 | 5.99 ± 0.02 | 7.01 ± 0.02 | 7.02 ± 0.02 |
| 1.0N NaOH | | | | | | | |
| Viscosity (cp) | Less than | Less than | Less than | Less than | Less than | Less than | Less than |
| @60 RPM, | 10 cp | 10 cp | 10 cp | 10 cp | 10 cp | 10 cp | 10 cp |
| 22° C.) | | | | | | | |

⁷1 ml of spore solution contain 10⁸ colony forming units (CFUs) of Bacillus spore
Bacillus spores: Evozyme ®P500 BS7, Genesis Biosciences, Cardiff

### Method 2: Pelletization of Bacillus Spore Pretreated in Liquid Fabric Care Composition

The following method was used for incubation and pelletization of Bacillus spores in all seven (7) sample listed in Table 2. About 10 ml of each sample was aseptically pipetted in sterile 15 mL Conical Centrifuge Tubes Cat. No. 430052 (VWR Int., West Chester, PA) and placed on the Rocking Platform (Serial #2110053, VWR Int., West Chest, PA) the entire time until sampled for analysis. The Rocking platform was set at 20 RPM and the samples were at room temperature. After day 1 (24 hr) each sample was sampled by aseptically pipetting 1 ml into sterile 15 mL Conical Centrifuge Tube and centrifuged at 3000 RPM for 3 minutes on Thermo Scientific Centrifuge, Cat No. 75004261 (Thermo Scientific, Germany) to recover the Bacillus spore pellet at the bottom of the conical centrifuge tube. The supernatant was discarded, and the pellet was rinsed in DI water (Cas no. 7732-18-5 ASTM Type II, VWR Chemicals BDH®) by first reconstituting it in 10 mL of DI water (Cas no. 7732-18-5 ASTM Type II, VWR Chemicals BDH®) in the same centrifuge tube and centrifuged at 300 RPM for 3 min. The supernatant was discarded, and the pellet reconstituted in 1 ml of DI water (ASTM Type II, VWR Chemicals BDH®) and held at room temperature until needed.

### Germination of Pelletized of Pretreated Bacillus Spores

The 24 hr samples were prepared according to Method 2. About 100 μl of each sample was transferred into Falcon® 96-well Clear Flat Bottom plate (REF 351172, Corning Inc, Corning, NY) using the Rainin Multichannel Pipettor 20-200 μL (SN: D1225484T, VWR International, West Chester, PA) and diluted in DI water to various dilutions of (24 hr sample: DI water) 1:1, 1:2, 1:4, 1:8 to determine the normalized dilutions of each sample with similar absorbance units at 600 nm. The SpectraMax M3, Multi-Mode Microplate Reader (SN 05589 Molecular Devices, CA) was used to measure the absorbance or optical density (OD) at 600 nm. The dilutions with similar OD were selected for germination profiles. About 80 μl of the Trypticase Soy Broth (TSB) (Cat. No. G82., Hardy Diagnostics, Santa Maria, CA) growth medium was pipetted into Falcon® 96-well Clear Flat Bottom plate (REF 351172, Corning Inc, Corning, NY) with Rainin Multichannel Pipettor 20-200 μL: SN: D1225484T (VWR International, West Chester, PA) with Micropipette, 20-200 μL, Rainin Pipet-Lite ID: D1225484T (Rainin Instrument, LLC, Oakland, CA). To the TSB medium 20 μL of the normalized dilutions of sample. The plate was sealed with BRAND® sealing film (Part no. BR781390, MilliporeSigma, Burlington, MA) followed by the lid to avoid evaporation during the analysis. The plate was placed in the SpectraMax M3, Multi-Mode Microplate Reader SN 05589 (Molecular Devices, CA) to generate growth curves by measuring the OD every 5 minutes for a duration of 1 hour at 35 C. The time when germination was triggered was defined as the time when the growth curve reached a preset germination threshold which was recorded as the Germination time (GT).

### Results of Germination Triggering of Bacillus Spores in Liquid Fabric Care Composition

The detection time was recorded as the % of Germination time (GT) relative to the DI water control (SMP #7). The control sample was set to 100% time to calculate the normalized GT in the rest of the samples using this following equation

$$\% Germination Time ( G T ) = \frac{Detection time ( SMP \# )}{Detection time of the control} \times 100$$

TABLE 3

| | Contains Composition 1 | | | | | | DI H2O |
|---|---|---|---|---|---|---|---|
| | SMP #1 | SMP #2 | SMP #3 | SMP #4 | SMP #5 | SMP #6 | SMP #7 |
| Composition pH | pH 2.0 ± | pH 3 ± | pH 4 ± | pH 5 ± | pH 5.99 ± | pH 7.01 ± | pH 7.02 ± |
| | 0.02 | 0.02 | 0.02 | 0.02 | 0.02 | 0.02 | 0.02) |
| % Germination | 31% | 37% | 47% | 53% | 71% | 75% | 100% |
| time (low % = | | | | | | | |
| faster | | | | | | | |
| germination) | | | | | | | |

The 24 hr incubation of SMP #1, SMP #2 and SMP #3 at pH 2, pH3 and pH4 respectively triggered early germination of the spores into bacterial cells once the spores were removed from the low pH composition relative to the control by requiring less than 50% of the time for germination to be triggered.

### CONCLUSIONS

The data show that the Bacillus spores that have been in the compositions of the invention germinate faster than Bacillus spores that have been in compositions at pH 5-7.

It was also observed that the Bacillus spores stored at room temperature in the composition of the invention for over 18 months did not prematurely germinate in product and it was confirmed that they still remain viable and capable of germinating on Trypticase Soy Agar 100×15 mm plates (Cat No. G60 Hardy Diagnostics, Santa Maria, CA).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid fabric care composition comprising:
i) from about 10% to about 50%, by weight of the composition, of an organic acid and/or a salt thereof;
ii) from about 1×10² to about 1×10⁹ CFU/ml of the composition, of Bacillus spores;
iii) a fragrance material comprising aldehydic perfume raw materials; and
iv) from about 30% to about 90%, by weight of the composition, of water;
wherein the composition comprises about 10% or less, by weight, of a material selected from the group consisting of detersive surfactant, bleaching systems, fabric softening materials, and mixtures thereof;
wherein the composition has a neat pH of from about 2 to about 4.

2. The liquid fabric care composition according to claim 1, wherein the organic acid comprises citric acid, acetic acid, lactic acid, adipic acid, aspartic acid, carboxymethyloxymalonic acid, carboxymethyloxysuccinic acid, glutaric acid, hydroxyethlyliminodiacetic acid, iminodiactic acid, maleic acid, malic acid, malonic acid, oxydiacetic acid, oxydisuccinic acid, succinic acid, sulfamic acid, tartaric acid, tartaric-discuccinic acid, tartaric-monosuccinic acid, a salt thereof, or a mixture thereof.

3. The liquid fabric care composition according to claim 1, wherein the composition comprises from 12% to 40%, by weight thereof, of citric acid, a citric acid salt, or a combination thereof.

4. The liquid fabric care composition according to claim 1, wherein the composition comprises from 15% to 30%, by weight thereof, of citric acid, a citric acid salt, or a combination thereof.

5. The liquid fabric care composition according to claim 1, wherein the composition comprises from about 0.001% to about 1.0%, by weight, of a first sulfur-containing compound comprising a sulfate compound, a bisulfate compound, or a combination thereof.

6. The liquid fabric care composition according to claim 5, wherein the sulfur-containing compound is selected from the group consisting of an alkali metal sulfate, an alkali metal bisulfate, an alkaline earth metal sulfate, an alkaline earth metal bisulfate, sulfuric acid, and combinations thereof.

7. The liquid fabric care composition according to claim 5, wherein the sulfur containing compound comprises sodium bisulfate.

8. The liquid fabric care composition according to claim 1, wherein the fragrance material comprises from about 10% to about 50%, by weight of the fragrance material of aldehydic perfume raw materials.

9. The liquid fabric care composition according to claim 8, wherein the composition comprises from about 0.2% to about 5%, by weight, of the fragrance material.

10. The liquid fabric care composition according to claim 1, wherein the composition comprises from about 60% to 85%, by weight, of water.

11. The liquid fabric care composition according to claim 1, wherein the composition comprises about 1% or less, by weight of a material selected from the group consisting of detersive surfactant, bleaching systems, fabric softening materials, and combinations thereof.

12. The liquid fabric care composition according claim 1, wherein the composition comprises from about 1% to about 5%, by weight, of nonionic surfactant.

13. The liquid fabric care composition according to claim 1, wherein the composition has a neat pH of from 2.3 to 3.7.

14. The liquid fabric care composition according to claim 1, wherein the composition has a percent transmittance (% T) of at least 60% of light using a 1 centimeter cuvette, at a wavelength of 410-800 nanometers when the composition comprises about 1% or less of dyes.

15. The liquid fabric care composition according to claim 1, wherein the composition has a viscosity of from 0 to about 100 cps as determined by rotational viscometry using a Brookfield viscometer and ASTM D 2196-99 at 60 RPM and 22° C.

16. The liquid fabric care composition according to claim 1, wherein the composition does not contain 2.80% by weight, of vinegar.

17. The liquid fabric care composition according to claim 1, wherein the composition comprises:
i) from 15% to 35%, by weight, of citric acid and/or a salt thereof;
ii) from about 1×10³ to about 1×10⁸ CFU/ml of the composition of Bacillus spores;
iii) from 0.1% to 5%, by weight, of the fragrance material;
iv) optionally from 0.1% to 5%, by weight, of a non-ionic surfactant; and
v) from 30% to 90%, by weight, of water;
wherein the composition comprises less than 5%, by weight, of a material selected from the group consisting of detersive surfactant, bleaching systems, fabric softening materials, and mixtures thereof.

18. The liquid fabric care composition according to claim 17, wherein the composition is packaged in a transparent or translucent container.

19. A process for making the liquid fabric care composition according to claim 12, the process comprising the step of mixing the fragrance material with the nonionic surfactant prior to being mixed with the organic acid.

20. A method of treating a fabric, said method comprising the steps of:
combining a laundry additive composition with water to form a rinse liquor in a vessel, wherein the laundry additive composition comprises an organic acid and from about 1×10³ to about 1×10⁹ CFU/ml of the composition of Bacillus spores,
wherein the rinse liquor has a pH of from 2 to 4 and wherein the laundry additive composition comprises less than 10%, by weight of the laundry additive composition, of a material selected from the group consisting of detersive surfactant, bleaching systems, fabric softening materials, and mixtures thereof;
contacting a fabric with the rinse liquor in the vessel and agitating the fabric; and
removing the rinse liquor from the vessel.
